(19) United States
(12) Patent Application Publication
(10) Pub. No.: US 2024/0085616 A1
(43) Pub. Date: Mar. 14, 2024

(54) LCD Display with a Non-Viewable Active Area

(71) Applicant: Lincoln Technology Solutions, Inc., Cary, NC (US)

(72) Inventor: Jacob Warren Kimbrell, Raleigh, NC (US)

(21) Appl. No.: 17/941,541

(22) Filed: Sep. 9, 2022

(51) Int. Cl. F21V 8/00; G02F 1/1335

(52) U.S. Cl. CPC G02B 6/0073; G02F 1/133514; G02F 1/133528; G02F 2201/50

(57) ABSTRACT

A liquid crystal display (LCD) that includes an active area. The active area includes a liquid crystal layer and a color filter layer and is configured to receive light from a backlight. The active area includes a viewable area in which content is displayed and visible to a user. The active area also includes a non-viewable area in which content is not visible.

### TECHNICAL FIELD

The present application is directed generally to liquid crystal displays and, more specifically, to liquid crystal displays that have an active area with a viewable area in which displayed content is visible and a non-viewable area in which no content is visible.

### BACKGROUND

A liquid crystal display (LCD) includes a backlight that emits light through a series of layers including liquid crystal cells to produce an image. A wide variety of electronic devices are LCDs including but not limited to 706 televisions, computer monitors, digital clocks, calculators, and smartphones. LCDs are also used as components in a variety of larger products, such as within displays in vehicles, electrical appliances, and consumer electronic products.

The backlight of an LCD includes one or more lights that are mounted on or at a substrate, such as a printed circuit board. The lights can be spaced apart in a variety of configurations depending upon the lighting arrangement. Backlights include integrated circuit (IC) components that are mounted on the substrate and control the operation of the lights. The amount of available space on the substrate is limited making it difficult to place the IC components. This causes mechanical integration complexities with the design including positioning the IC components on the substrate or integrating another substrate to mount the IC components.

Another issue with LCD displays is the limited lighting options. This can result in the design having an undesirable lighting arrangement that can cause a variety of undesirable optical effects such as reflections and inadequate depth of field.

### SUMMARY

One aspect is directed to a liquid crystal display comprising a backlight configured to emit light in a first direction, a protective layer in an overlapping arrangement with the backlight, and layers positioned between and overlapping with the backlight and the protective layer with the layers comprising a liquid crystal cell layer and a color filter layer. An active area overlaps with the layers with the active area comprising a viewable area configured to display images that are visible through the protective layer and a non-viewable area in which images are not visible through the protective layer.

In another aspect, the backlight comprises a substrate and light emitting diodes with the light emitting diodes overlapping with both the viewable area and the non-viewable area.

In another aspect, the backlight comprises a substrate and one or more rail lights that extend along one or more edges of the substrate.

In another aspect, an inactive area is positioned laterally away from the active area with the inactive area positioned to be non-illuminated by the backlight.

In another aspect, the backlight comprises a substrate and light emitting diodes and with the inactive area overlapping with the substrate and non-overlapping with the light emitting diodes.

In another aspect, the backlight comprises a substrate and light emitting diodes with the light emitting diodes overlapping with the active area and laterally away from the inactive area.

In another aspect, the protective layer comprises a transparent section that forms the viewable area and an opaque section that forms the non-viewable area.

In another aspect, the layers further comprise a first polarizing film layer overlapping with and behind the liquid crystal cell layer, a second polarizing film layer overlapping with and in front of the liquid crystal cell layer, and one or more light guide and diffuser layers.

In another aspect, a housing comprises a body with an enclosed interior space and an opening with the liquid crystal display positioned in the interior space with the protective layer aligned within the opening.

One aspect is directed to a liquid crystal display comprising a protective layer, a backlight, a liquid crystal cell layer, and a color filter layer. An active area comprises a vertical stack of the cover layer, the backlight, the liquid crystal cell layer, and the color filter layer with the active area comprising a viewable active area in which a displayed image is visible through the protective layer and a non-viewable active area in which the displayed image is not visible through the protective layer.

In another aspect, the liquid crystal cell layer and the color filter layer are positioned between the protective layer and the backlight.

In another aspect, the backlight comprises a substrate and a plurality of light emitting diodes with the light emitting diodes vertically aligned with both the viewable active area and the non-viewable active area.

In another aspect, the backlight comprises a substrate and one or more rail lights that extend along one or more edges of the substrate.

In another aspect, the protective layer comprises a transparent section that forms the viewable active area and an opaque section that forms the non-viewable active area.

In another aspect, a first polarizing film layer is positioned vertically below the liquid crystal cell layer, a second polarizing film layer is positioned vertically above the liquid crystal cell layer, and one or more light guide and diffuser layers.

In another aspect, the display includes a housing comprising a body with an enclosed interior space and an opening with the LCD display positioned in the interior space with the protective layer aligned within the opening.

One aspect is directed to a liquid crystal display comprising a backlight configured to emit light in a first direction, a diffuser/light guide layer vertically stacked in the first direction over the backlight, a polarizing film layer vertically stacked in the first direction over the backlight, a thin film transistor layer vertically stacked in the first direction over the backlight, a liquid crystal cell layer vertically stacked in the first direction over the backlight, a color filter layer vertically stacked in the first direction over the backlight, and an active area comprising a viewable active area in which displayed images are visible and a non-viewable active area in which the displayed image are not visible.

In another aspect, the display includes a protective layer stacked in the first direction over the backlight.

In another aspect, the protective layer is a cover layer.

In another aspect, the polarizing film layer comprises a first polarizing film layer positioned vertically below the liquid crystal cell layer and the color filter layer and a second polarizing film layer positioned vertically above the liquid crystal cell layer and the color filter layer.

The various aspects of the various embodiments may be used alone or in any combination, as is desired.

### BRIEF DESCRIPTION OF THE DRAWINGS

FIG. 1 is an exploded perspective view of an LCD display.

FIG. 2 is an exploded perspective view of a backlight layer and a liquid crystal cell layer.

FIG. 3 is a schematic front view of a liquid crystal cell layer having pixels with multiple subpixels.

FIG. 4 is a schematic front view of a display with an active area 50 that includes a viewable active area positioned adjacent to a non-viewable active area.

FIG. 5 is a schematic front view of a display with a pair of viewable active areas and an intermediate non-viewable active area.

FIG. 6 is a schematic front view of a display with a circular viewable active area positioned within and surrounded by a non-viewable active area.

FIG. 7 is a front view of a backlight with LEDs positioned within a limited area of a substrate.

FIG. 8 is an exploded perspective view of an LCD display.

FIG. 9 is an exploded perspective view of an LCD display.

FIG. 10 is a schematic front view of an LCD display with both an active area and an inactive area.

FIG. 11 is a front view of a portion of a liquid crystal display including a backlight and a frame.

FIG. 12 is a perspective view of an electronic device that includes an LCD display.

FIG. 13 is an exploded perspective view of an LCD display.

FIG. 14 is an exploded perspective view of an LCD display that includes a screen of a housing.

FIG. 15 is an exploded perspective view of an LCD display.

### DETAILED DESCRIPTION

The present application is directed to a liquid crystal display (LCD) that includes an active area. The active area overlaps with a liquid crystal cell layer and a color filter layer and is configured to receive light from a backlight. The active area includes a viewable area in which content is displayed and visible to a user. The active area also includes a non-viewable area in which content is not visible.

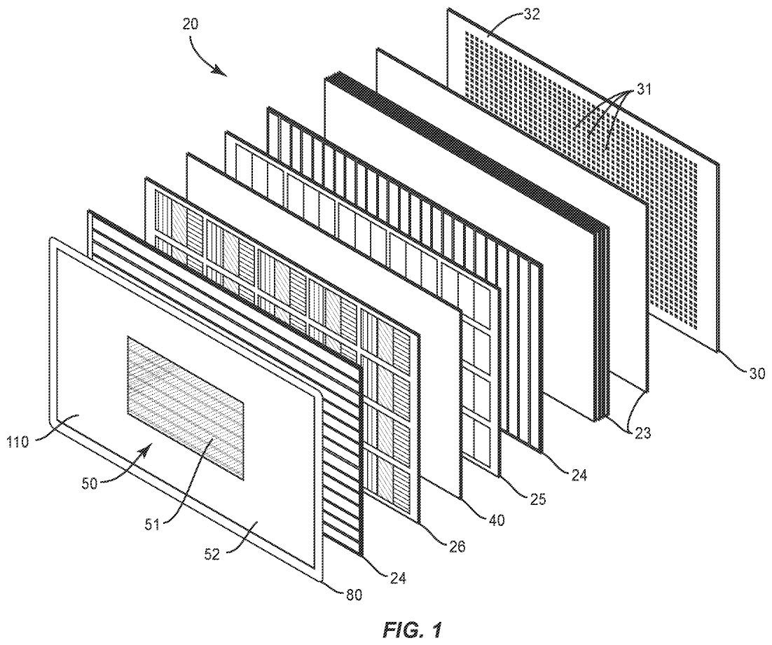

FIG. 1 illustrates an example of an LCD display 20 that includes overlapping layers positioned in front of a backlight 30. The layers include a diffusor and lightguide 23, polarizing film 24, a thin film transistor (TFT) 25, liquid crystal cell 40, color filter 26, and a protective layer 110. In this example, the protective layer 110 is a cover layer 80. The number of layers and the arrangement of the layers can vary depending upon the use with FIG. 1 disclosing one arrangement. The layers are in an overlapping arrangement such that light produced from the backlight 30 is directed through the layers to display images that are visible in an active area 50 at the cover layer 80. In one example as illustrated in FIG. 1, the size and shape of the layers is substantially the same. Other examples include the layers having different shapes and/or sizes.

In one example, the elements of the LCD display 20 are referred to as being vertically stacked. This overlapping configuration provides for the different layers to be positioned at various locations along the vertical stack. For example, the liquid crystal cell layer 40 is above the backlight 30 and below the cover layer 20. In another example, polarizing films 24 are positioned both above and below the liquid crystal cell layer 40.

The backlight 30 is positioned behind and provides backlighting to the layers including the liquid crystal cell layer 40. In the example of FIG. 1, the backlight 30 provides direct lighting to the layers. The backlight 30 includes individual LEDs 31 that are mounted on a substrate 32 such as a printed circuit board. The LEDs 31 are individually controlled to different settings to provide different brightness levels. The LEDs 31 can include a variety of different arrangements. One arrangement includes an array of LEDs 31 with a 16:9 aspect ratio.

The LEDs 31 can be operated in a number of different settings. In one example, each LED is individually controlled and set to a lighting level. In another example, the LEDs 31 are divided into zones that can each be controlled separately to provide different brightness levels (referred to as full-array local dimming (FALD)).

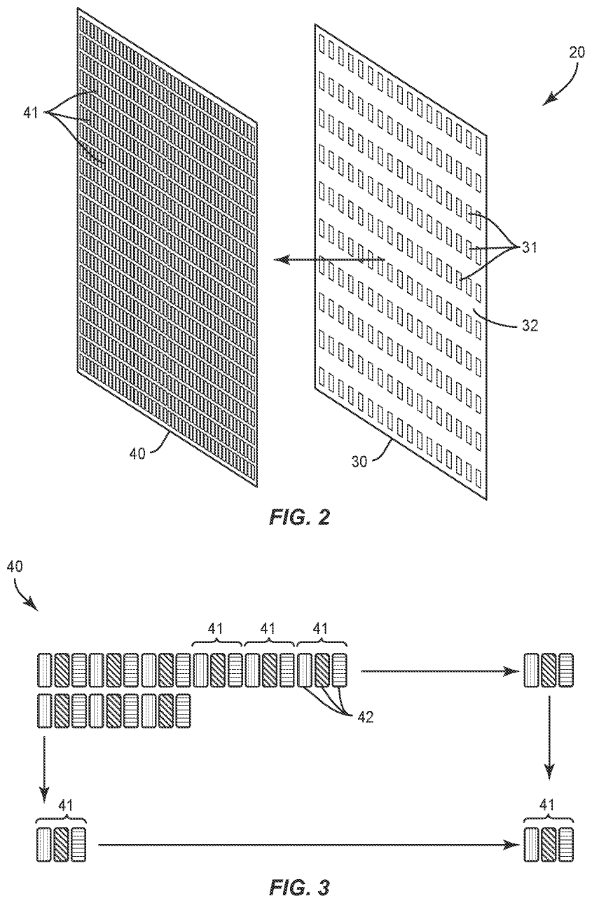

The light from the backlight 30 passes through the liquid crystal cell layer 40. As illustrated in FIGS. 2 and 3, the liquid crystal cell layer 40 includes an array of pixels 41 that are arranged in various sizes and shapes. One design features a 1920×1080 array (i.e., 1920 pixels in each of the 1080 rows). Each pixel 41 includes multiple sub-pixels 42. In one example, each pixel 41 includes three sub-pixels 42: a red sub-pixel; a green sub-pixel; and a blue sub-pixel (i.e., an RGB pixel). The sub-pixels 42 can be adjusted to different luminance values to cause the pixels 41 to have various colors. One design includes the liquid crystal cell 40 being a 24-bit display that can yield a total of 16.7 million colors.

The light guide and diffuser layer 23 directs the light from the backlight 30 to the liquid crystal cell layer 40. The layer 23 provides for better light uniformity and brighter transfer of light. The layer 23 can be made from various materials, including but not limited to plastic, glass, and poly(methyl methacrylate) (PMMA).

The polarizing film layer 24 is positioned in proximity to the liquid crystal cell layer 40. In one example, the polarizing film layer 24 includes layers positioned on the opposing sides of the liquid crystal cell layer 40. In one example, one polarizing film layer 24 has a vertical axis and another polarizing film layer 24 has a horizontal axis with the axes perpendicular to each other.

The TFT layer 25 provides an appropriate voltage for individual subpixels 42 of the liquid crystal cell 40 to provide for an active matrix. In one example, the TFT layer 25 is positioned between the polarizing film layers 24.

The color filter layer 26 absorbs light in specific wavelength ranges and allows other wavelength ranges to pass. As light travels from the backlight 30, the color filter layer 26 blocks the unnecessary colors. The color filter layer 26 can be a single layer, or multiple layers (e.g., a layer for red light, a layer for green light, and a layer for blue light).

The protective layer 110 is positioned at the front of the LCD display 20. In one example, the protective layer 110 is a cover layer 80 bonded onto the LCD display 20. The cover layer 80 provides protection to the LCD display 20. In one example, a touch layer is positioned in or behind the cover layer 80.

The various layers can include a single layer of material or multiple layers of materials. In the multiple layer embodiments, the layers can be the same or different materials. The LCD display 20 can also include additional layers than those shown in FIG. 1. Additionally or alternatively, the LCD display 20 does not include one or more of the layers shown in FIG. 1. In one example, the light guide and diffuser layer 23 includes one or more diffusors, gamut films, brightness enhancement films, and lightguides. In one specific example, the layer 23 includes quantum dot enhancement film (qdef).

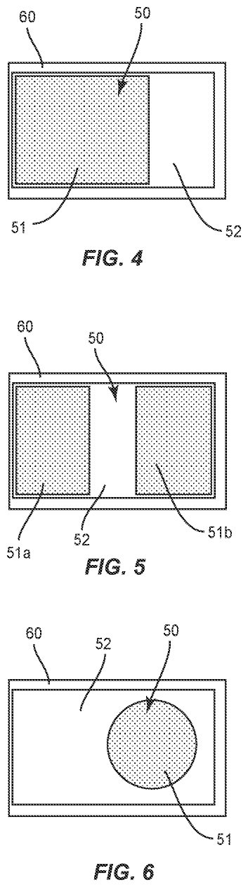

The LCD display 20 has an active area 50 formed at the overlap of the pixels 41 of the liquid crystal cell layer 40 and the color filters 26. The active area 50 includes a viewable active area 51 in which the images are visible to a user through the cover layer 80. The active area 50 also includes a non-viewable active area 52 in which images are not visible. The viewable active area 51 can have various shapes, shapes and sections and be positioned at various locations on the cover layer 80. FIG. 1 includes an example with the viewable active area 51 having a rectangular shape and centered on the cover layer 80 with the non-viewable active area 52 extending around the exterior. FIG. 4 includes an example in which the active area 50 includes a viewable active area 51 positioned adjacent to a non-viewable active area 52. FIG. 5 includes an example with a pair of viewable active area sections 51a, 51b with an intermediate non-viewable active area 52. FIG. 6 includes a circular viewable active area 51 positioned within and surrounded by a non-viewable active area 52.

The non-viewable active area 52 includes one or more sections in which images are not visible. The non-viewable active area 52 can be caused by one or more of the illumination of the backlight 30 and the cover 80.

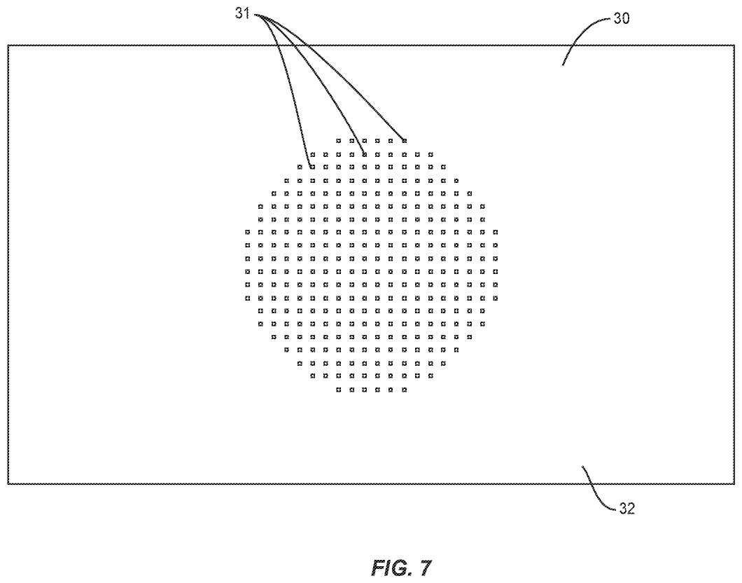

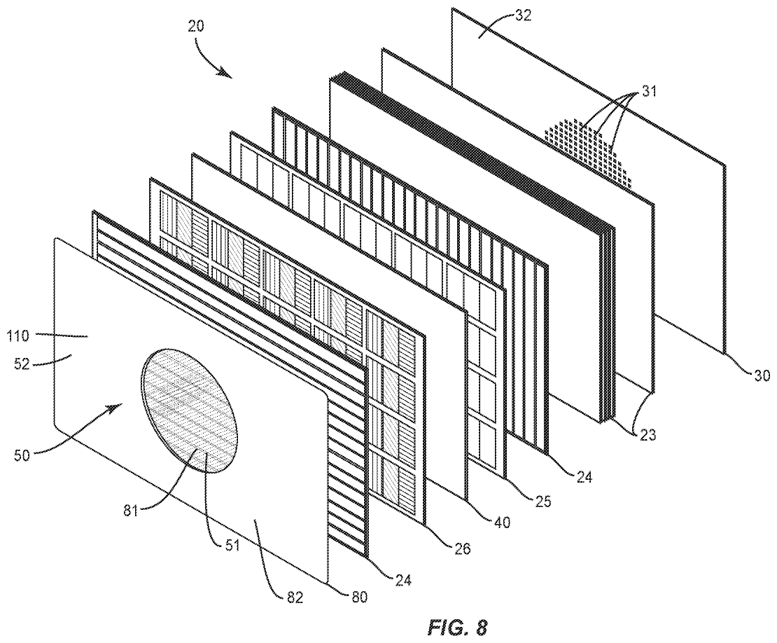

In one example, the backlight 30 is configured such that light is not emitted at the non-viewable active area 52 and thus no images are created for this area 52. In one specific example, the LEDs 31 are controlled to provide light to display images to just the viewable active area 51 while no light is into the non-viewable active area 52. One example as illustrated in FIG. 7 includes the backlight 30 with LEDs 31 positioned along a limited area of the substrate 32. This configuration causes light to be emitted to a limited section of the display that corresponds to the viewable active area 51 without emitting light into the non-viewable active area 52. A remainder of the substrate 32 is without LEDs 31 and aligns with the non-viewable active area 52. FIG. 8 illustrates a similar backlight 30 in overlapping arrangement with the other layers of the LCD display 20.

Additionally or alternatively, the protective layer 110 forms the viewable active area 51 and the non-viewable active area 52. In one example, the cover layer 80 includes a viewing section 81 that forms the viewable active area 51. The viewing section 81 overlaps with the liquid crystal cell layer 40 and the color filter layer 26. In one example, the viewing section 81 is a transparent material such as plastic or glass through which the displayed image is viewable by a user.

In one example, the cover layer 80 includes a cover section 82 that overlaps with the liquid crystal cell layer 40 and the color filter layer 26 and prevents the user from visually seeing the underlying layers of the LCD display 20. The cover section 82 is an opaque material. In one example, the cover section 82 is constructed from an opaque plastic film that is attached to the face of the cover layer 80.

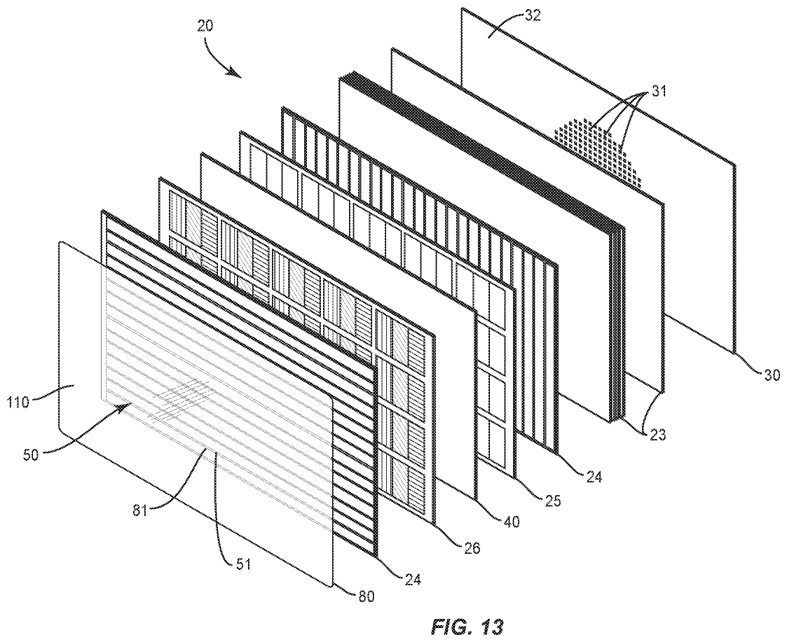

In another example as illustrated in FIG. 13, the entire cover layer 80 is transparent across the LCD display 20 and does not include a cover section 82. In this example, the entire cover layer 80 forms the viewing section 81 and the non-viewable active area 52 is formed in a different manner (e.g., LEDs 31 positioned along a limited area of the backlight 30 as illustrated in FIGS. 7 and 8).

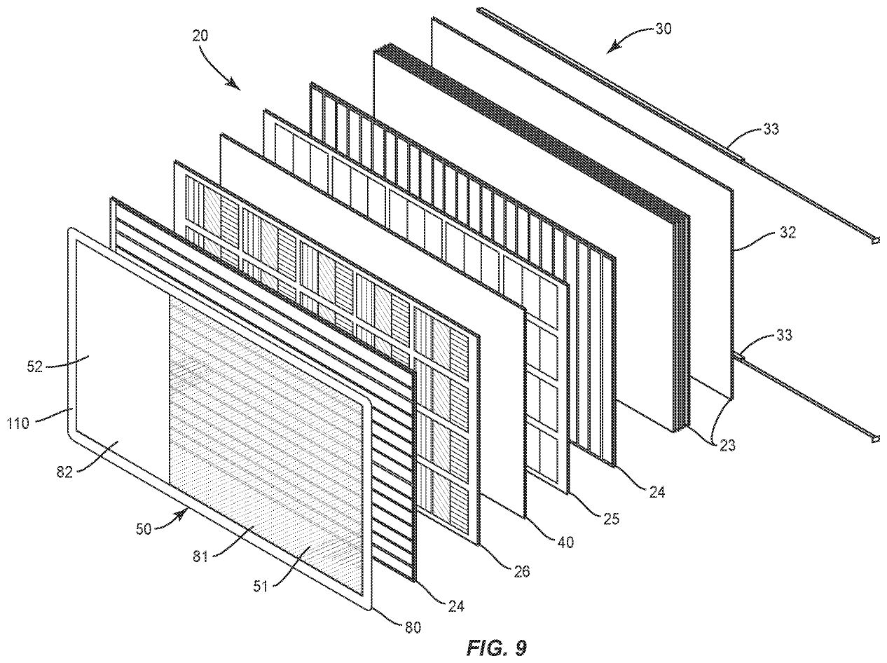

The backlight 30 can include various configurations. In one example as described above, the backlight comprises an array of LEDs 31 mounted on the substrate 32. In another example as illustrated in FIG. 9, the backlight 30 includes an edge-lit configuration. Elongated lights 33, such as light rails, extend along one or more of the edges of the substrate 32. The lights 33 project light parallel to the active area 50 and the diffuser and light guide layer 23 direct the light out to the user. FIG. 9 includes an example with a pair of lights 33 that extend along two opposing sides of the substrate 32. In another example, lights 33 extend along each of the sides of the substrate 32 (e.g., along each of the four sides of the rectangular substrate 32).

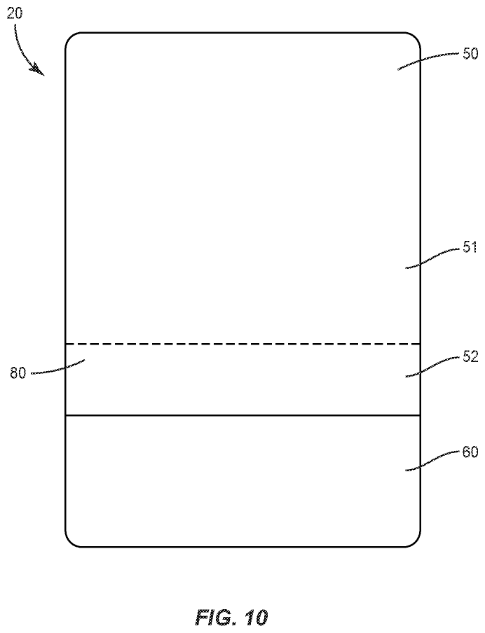

In addition to an active area 50, the LCD display 20 also includes an inactive area 60. The inactive area 60 does not overlap with the liquid crystal cell layer 40 and therefore does not display images. In one example, the inactive area 60 also does not overlap with the color filter layer 36. FIG. 10 illustrates an example of an LCD display 20 with both an active area 50 and an inactive area 60. The active area 50 includes the viewable active area 51 in which images are visible and the non-viewable active area 52 where images are not visible. The inactive area 60 is positioned away from the active area 50. FIG. 10 includes an example with the inactive area 60 positioned along one side of the active area 50. In another example, the inactive area 60 extends around the active area 50.

In one example, the cover layer 80 is positioned away from the inactive area 60. In another example, the cover layer 80 extends over and overlaps with the inactive area 60. In a specific example, the cover section 82 of the cover layer 80 overlaps with the inactive area 60.

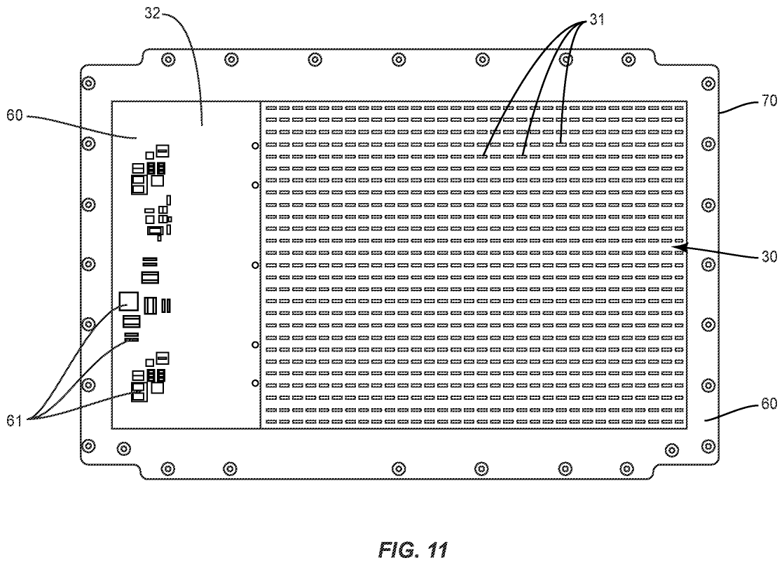

FIG. 11 illustrates a portion of a liquid crystal display 20 that includes the backlight 30 and a frame 70. The layers in front of the backlight 30 have been removed for clarity. The inactive area 60 extends around a perimeter of the backlight 30 and is formed by the frame 70. The inactive area 60 does not include the LEDs 31 and is not illuminated. The inactive area 60 further includes a section formed by the substrate 32 of the backlight 30 that is positioned away from the LEDs 31. One or more sections of the inactive area 60 provides space within the interior of the LCD display 20 to mount electrical components 61 configured for the operation. Examples of electrical components 61 include but are not limited to resistors, capacitors, transistors, switches, and integrated circuits. In one example, one or more of the components 61 are included in a control unit 35.

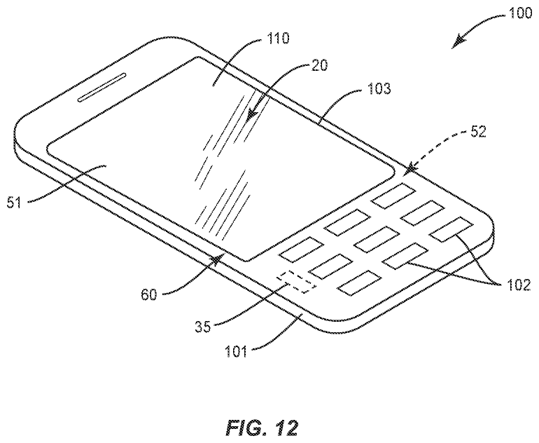

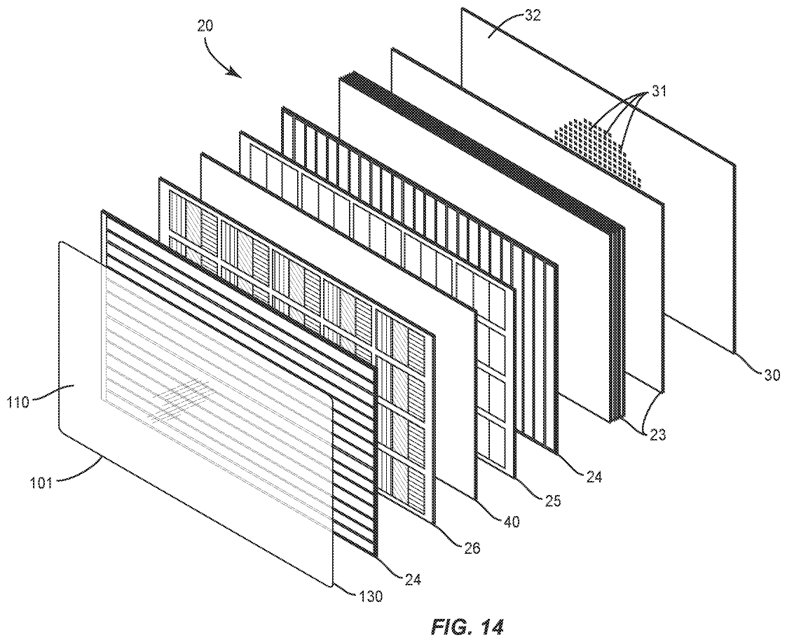

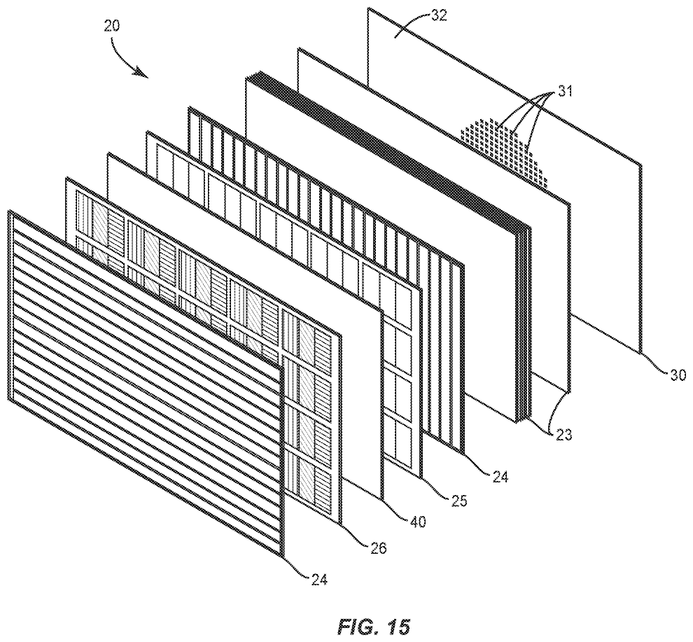

FIG. 12 illustrates an LCD display 20 incorporated within an electronic device 100. The LCD display 20 is positioned within a housing 101 of the electronic device 100. The LCD display 20 is positioned in the housing 101 with the viewable active area 51 aligned with an opening 103 in the housing 101. The housing 101 includes a screen 130 that forms the protective layer 110. In one example, the LCD display 20 does not include a cover layer 80. FIG. 14 illustrates an LCD display 20 with the housing 101 including a screen 130 that forms the protective layer 110. FIG. 14 illustrates just the screen 130 with a remainder of the housing 101 removed for clarity. In one example, the housing 101 includes an interior space with the backlight 30 and other layers of the LCD display 20 positioned in the interior space and aligned with the screen 130. In another example, the LCD display 20 includes a cover layer 80 that is positioned beneath the protective layer 110. The non-viewable active area 52 and inactive area 60 are positioned within the housing 101 and not visible from the exterior of the housing 101. One or more user inputs 102, such as buttons, touch screens, trac ball, etc. can extend from one or both of the non-viewable active area 52 and inactive area 60 and be exposed on the exterior of the housing 101 to provide for inputting commands to the electronic device 100.

In one example with the protective layer 110 formed by the screen 130 of the housing 130, the screen 130 is completely transparent. In another example, the screen 130 includes one or more transparent sections that forms the viewable area 51 and one or more opaque sections that forms the non-viewable area 52.

In the examples disclosed above, the LCD display 20 includes a protective layer 110. In another example, the LCD display 20 does not include a protective layer 110. FIG. 15 illustrates an example of an LCD display 20 without a protective layer 110.

The control unit 35 is configured to operate the LCD display 20. The control unit 35 includes control circuitry and a memory circuitry. The control circuitry controls overall operation according to program instructions stored in the memory circuitry. The control circuitry can include one or more circuits, microcontrollers, microprocessors, hardware, or a combination thereof. Memory circuitry includes a non-transitory computer readable storage medium storing program instructions, such as a computer program product, that configures the control circuitry to implement one or more of the techniques discussed herein. Memory circuitry can include various memory devices such as, for example, read-only memory, and flash memory. In one example, the control unit 35 includes communications circuitry to send and receive information. The communications circuit can include one or more interfaces that provide for different methods of communication. The control unit 35 can also include a power source to provide power.

In one example, the control unit 35 includes Field Programmable Gate Arrays (FPGA) that control LED drivers which control the LEDs 31. The FPGAs can include internal memory and/or are loaded/programmed at power up.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A liquid crystal display comprising:
a backlight configured to emit light in a first direction;
a protective layer in an overlapping arrangement with the backlight;
layers positioned between and overlapping with the backlight and the protective layer, the layers comprising a liquid crystal cell layer and a color filter layer;
an active area that overlaps with the layers, the active area comprising:
a viewable area configured to display images that are visible through the protective layer; and
a non-viewable area in which images are not visible through the protective layer.

2. The liquid crystal display of claim 1, wherein the backlight comprises a substrate and light emitting diodes with the light emitting diodes overlapping with both the viewable area and the non-viewable area.

3. The liquid crystal display of claim 1, wherein the backlight comprises a substrate and one or more rail lights that extend along one or more edges of the substrate.

4. The liquid crystal display of claim 1, further comprising an inactive area that is positioned laterally away from the active area, the inactive area positioned to be non-illuminated by the backlight.

5. The liquid crystal display of claim 4, wherein the backlight comprises a substrate and light emitting diodes and with the inactive area overlapping with the substrate and non-overlapping with the light emitting diodes.

6. The liquid crystal display of claim 1, wherein the backlight comprises a substrate and light emitting diodes with the light emitting diodes overlapping with the active area and laterally away from the inactive area.

7. The liquid crystal display of claim 1, wherein the protective layer comprises:
a transparent section that forms the viewable area; and
an opaque section that forms the non-viewable area.

8. The liquid crystal display of claim 1, wherein the layers further comprise:
a first polarizing film layer overlapping with and behind the liquid crystal cell layer;
a second polarizing film layer overlapping with and in front of the liquid crystal cell layer; and
one or more light guide and diffuser layers.

9. The liquid crystal display of claim 1, further comprising a housing comprising a body with an enclosed interior space and an opening with the liquid crystal display positioned in the interior space with a cover layer aligned within the opening.

10. A liquid crystal display comprising:
a protective layer;
a backlight;
a liquid crystal cell layer;
a color filter layer;
an active area comprising a vertical stack of the backlight, the liquid crystal cell layer, and the color filter layer, the active area comprising:
a viewable active area in which a displayed image is visible through the protective layer; and
a non-viewable active area in which the displayed image is not visible through the protective layer.

11. The liquid crystal display of claim 10, wherein the liquid crystal cell layer and the color filter layer are positioned between the protective layer and the backlight.

12. The liquid crystal display of claim 10, wherein the backlight comprises a substrate and a plurality of light emitting diodes with the light emitting diodes vertically aligned with both the viewable active area and the non-viewable active area.

13. The liquid crystal display of claim 10, wherein the backlight comprises a substrate and one or more rail lights that extend along one or more edges of the substrate.

14. The liquid crystal display of claim 10, wherein the protective layer comprises:
a transparent section that forms the viewable active area; and
an opaque section that forms the non-viewable active area.

15. The liquid crystal display of claim 10, further comprising:
a first polarizing film layer positioned vertically below the liquid crystal cell layer;
a second polarizing film layer positioned vertically above the liquid crystal cell layer; and
one or more light guide and diffuser layers.

16. The liquid crystal display of claim 10, further comprising a housing comprising a body with an enclosed interior space and an opening with the liquid crystal display positioned in the interior space with the protective layer aligned within the opening.

17. A liquid crystal display comprising:
a backlight configured to emit light in a first direction;
a diffuser/light guide layer vertically stacked in the first direction over the backlight;
a polarizing film layer vertically stacked in the first direction over the backlight;
a thin film transistor layer vertically stacked in the first direction over the backlight;
a liquid crystal cell layer vertically stacked in the first direction over the backlight;
a color filter layer vertically stacked in the first direction over the backlight;
an active area comprising a viewable active area in which displayed images are visible and a non-viewable active area in which the displayed image are not visible.

18. The liquid crystal display of claim 17, further comprising a protective layer stacked in the first direction over the backlight.

19. The liquid crystal display of claim 18, wherein the protective layer is a cover layer.

20. The liquid crystal display of claim 17, wherein the polarizing film layer comprises a first polarizing film layer positioned vertically below the liquid crystal cell layer and the color filter layer and a second polarizing film layer positioned vertically above the liquid crystal cell layer and the color filter layer.
